(19) United States
(12) Patent Application Publication
(10) Pub. No.: US 2025/0378317 A1
(43) Pub. Date: Dec. 11, 2025

(54) APPARATUS AND COMPUTER-IMPLEMENTED METHOD FOR DETERMINING A MEMORY PLAN FOR EXECUTING OPERATIONS

(71) Applicant: Robert Bosch GmbH, Stuttgart (DE)

(72) Inventors: Benjamin Wagner, Friedrichshafen (DE); Duy Khoi Vo, Waiblingen (DE); Sebastian Boblest, Duernau (DE); Sven Markwart, Moeglingen (DE); Ulrik Hjort, Malmö (SE)

(21) Appl. No.: 19/209,298

(22) Filed: May 15, 2025

(30) Foreign Application Priority Data
May 24, 2024 (DE) 10 2024 204 829.1

(51) Int. Cl. G06N 3/063

(52) U.S. Cl. CPC G06N 3/063

(57) ABSTRACT

An apparatus and computer-implemented method for determining a memory plan for executing operations, in particular of an artificial neural network. A list of memory areas required for executing the operations is created, wherein, depending on the list, it is determined for the operations which memory areas must be present in a first memory for executing the particular operation and which memory areas may be present in a second memory during the execution of the particular operation, wherein the memory plan is determined depending on whether a memory area must be present in the main memory for execution or may be present in the secondary memory.

### FIELD

The present invention relates to an apparatus and a computer-implemented method for determining a memory plan for executing operations, in particular of an artificial neural network.

### BACKGROUND INFORMATION

An integral part of a code generator for neural networks is memory planning. It is responsible for managing the memory and determines at which addresses in the memory data is stored during the computation of the neural network.

German Patent No. DE 3232675 A1 describes a method for controlling data access in a computer and a data control system for carrying out the method.

### SUMMARY

According to an example embodiment of the present invention, a computer-implemented method for determining a memory plan for executing operations of an artificial neural network provides that a list of memory areas required for executing the operations is created, wherein, depending on the list, it is determined for the operations which memory areas must be present in a first memory for executing the particular operation and which memory areas may be present in a second memory during the execution of the particular operation, wherein the memory plan is determined depending on whether a memory area must be present in the first memory for execution or may be present in the second memory. The list allows for efficient computation of the memory plan, which can manage multiple memories simultaneously and minimize the number of copies required between memory areas.

For each operation, an assignment of the memory areas to either the first memory or the second memory is determined.

The assignment that minimizes a number of transfers of memory areas between the first memory and the second memory is determined. This reduces the amount of bytes that need to be transferred.

For example, the assignment is determined using a satisfiability modulo theories solver.

For each operation, the memory areas in the list that do not have to be in the first memory are marked, wherein the memory plan is determined depending on the list of marked memory areas.

According to an example embodiment of the present invention, the memory areas are provided, for example, for executing the operations according to the memory plan, wherein memory areas are transferred from the first memory to the second memory or are transferred from the second memory to the first memory according to the memory plan. This reduces the size of the required first memory and allows for use on hardware with limited first memory size. This approach has the advantage that multiple memories are used efficiently.

According to an example embodiment of the present invention, an apparatus for determining a memory plan for executing operations, in particular of an artificial neural network, comprises at least one processor and at least one memory, wherein the at least one memory comprises instructions which can be executed by the at least one processor and upon the execution of which by the at least one processor, the method of the present invention is executed.

According to an example embodiment of the present invention, a computer program can be provided, wherein the computer program comprises computer-readable instructions, during the execution of which by a computer the method of the present invention is executed.

Further advantageous embodiments of the present invention can be found in the following description and the figures.

### BRIEF DESCRIPTION OF THE DRAWINGS

FIG. 1 shows part of a network architecture of an artificial neural network.

FIG. 2 shows an exemplary memory plan, according to the present invention.

FIG. 3 shows a flow chart with steps of a method for determining the memory plan, according to an example embodiment of the present invention.

FIG. 4 shows an exemplary list of memory areas, according to an example embodiment of the present invention.

FIG. 5 shows an example of an assignment of memory areas, according to an example embodiment of the present invention.

FIG. 6 is a schematic representation of an apparatus for determining the memory plan, according to an example embodiment of the present invention.

### DETAILED DESCRIPTION OF EXAMPLE EMBODIMENTS

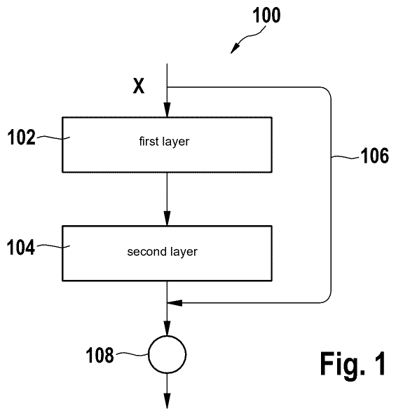

FIG. 1 shows part of a network architecture 100 of an artificial neural network.

The artificial neural network comprises a first layer 102 and a second layer 104.

The first layer 102 is configured to map an input x of the first layer 102 to an input of the second layer 104.

The second layer 104 is configured to map the input of the second layer 104 to an output of the second layer 104.

The first layer 102 and the second layer 104 apply a function F(x) to the input x.

The artificial neural network includes, for example, skip connections. A skip connection can skip only one layer or multiple layers of the network. For example, the skip connection makes it possible to incorporate an output of an inner layer of the artificial neural network back into the computation at a later time. This counteracts, for example, vanishing gradients and simplifies an optimization process when training the artificial neural network.

An example of a skip connection in the network architecture 100 is a connection 106 to an operand 108. The operand 108 applies an operation to the input x and the result of the function F(x). The connection 106 represents a skip connection which skips the first layer 102 and the second layer 104.

In the example, the operand 108 is addition, i.e., F(x)+x. The operand 108 can be another operation, e.g., multiplication or subtraction.

Skip connections result in increased memory requirements, in particular when computing on embedded hardware. For example, during computation, a temporary result, e.g., the input x, is kept in memory across multiple computation operations, e.g., computing the function F(x). Therefore, when available memory is limited, the memory remaining for computing the operations is reduced by the memory required to store the temporary result.

An extreme case is a network architecture in which the input of the artificial neural network is reused to compute the last layer of the artificial neural network.

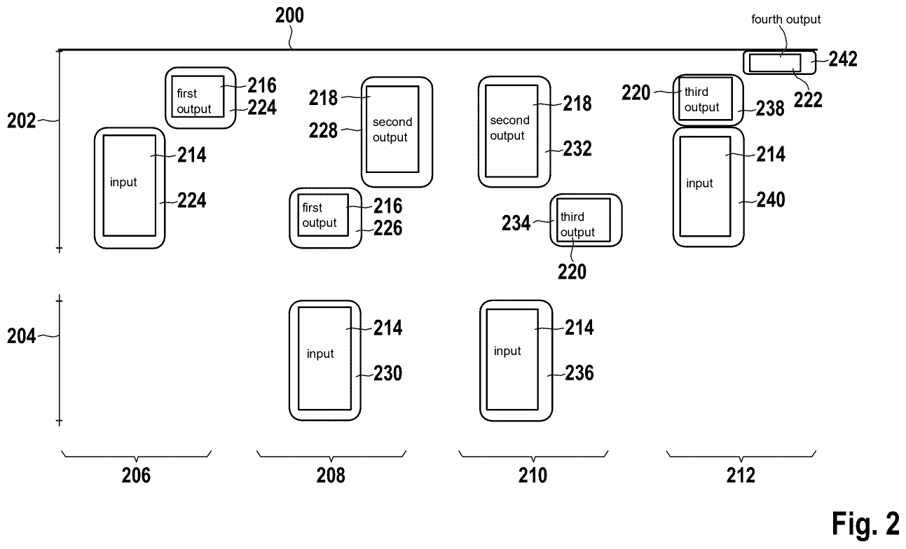

In this network architecture, only a limited amount of memory is available for practically the entire computation time. This is avoided by an exemplary memory plan 200 shown in FIG. 2.

The exemplary memory plan 200 provides for two memories for data: a first memory 202 and a second memory 204. The memories each have memory blocks. A memory block defines a memory area for the data.

The exemplary memory plan 200 provides for four operations: a first operation 206, a second operation 208, a third operation 210, and a fourth operation 212.

The first operation 206 processes an input 214. The first operation 206 generates a first output 216. The input 214 is assigned to the first memory 202. The first output 216 is assigned to the first memory 202.

The second operation 208 processes the first output 216. The second operation 208 generates a second output 218. The input 214 is assigned to the second memory 204. The second output 218 is assigned to the first memory 202.

The third operation 210 processes the second output 218. The third operation 210 generates a third output 220. The input 214 is assigned to the second memory 204. The third output 220 is assigned to the first memory 202.

The fourth operation 212 processes the input 214 and the third output 220. The fourth operation 212 generates a fourth output 222. The input 214 is assigned to the first memory 202. The fourth output 222 is assigned to the first memory 202.

The memory plan 200 provides that the operations run sequentially in time, wherein an output of an operation represents the input of an operation following that operation.

The input 214 is used in the first operation 206 and the fourth operation 212.

The input 214 is temporarily stored in the second memory 204 for the computation of the second operation 208 and the third operation 210. In the first memory 202, buffering the input 214 in the second memory 204 creates space for storing the second output 218 and the third output 222. The input 214 is stored in the first memory 202 for the computation of the first operation 206 and the fourth operation 212.

The memory plan 200 provides, for example, that the input 214 for the computation of the first operation 206 is stored in a first memory block 222 and the first output 216 is stored in a second memory block 224.

The memory plan 200 provides, for example, that the first output 216 for the computation of the second operation 208 is stored in a third memory block 226 and the second output 218 is stored in a fourth memory block 228.

For example, the memory plan 200 provides that the input 214 is stored in a fifth memory block 230 during the computation of the second operation 208.

The memory plan 200 provides, for example, that the second output 218 for the computation of the third operation 210 is stored in a sixth memory block 232 and the third output 222 is stored in a seventh memory block 234.

The memory plan 200 provides, for example, that the input 214 is stored in an eighth memory block 236 during the computation of the third operation 210.

The memory plan 200 provides, for example, that the third output 222 for the computation of the fourth operation 212 is stored in a ninth memory block 238, the input 214 is stored in a tenth memory block 238, and the fourth output 222 is stored in an eleventh memory block 244.

It can be provided that, when computing the memory plan 200, the number of copies required between the memory blocks is minimized by using the same memory area for the same data, if possible. This reduces the additional overhead caused by memory transfers while allowing significant memory savings.

For example, the memory plan 200 provides that the input 214 is copied from the first memory 202 to the second memory 204 in a memory block after the first operation 206, remains in the same memory block in the second memory 204 during the computation of the second operation 208 and the third operation 210, and is copied to a memory block in the first memory 202 for the computation of the fourth operation 212.

For example, the memory plan 200 provides that the first output 216 is copied into a memory block of the first memory 202 after the first operation 206 and is read from the same memory block for the computation of the second operation 208.

For example, the memory plan 200 provides that the first output 216 is copied into a memory block of the first memory 202 after the first operation 206 and is read from the same memory block for the computation of the second operation 208.

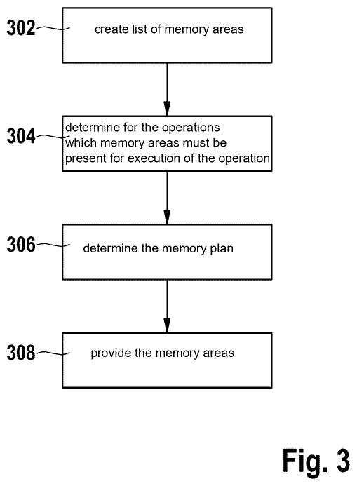

FIG. 3 shows a flow chart with steps of a method for determining a memory plan. The method is described using the example of the memory plan 200. The method uses a main memory for the computation of operations and a secondary memory for buffering. The main memory is, for example, the first memory 202. The secondary memory is, for example, the second memory 204.

The method comprises a step 302.

In step 302, a list of memory areas is created.

The memory areas have a specified lifetime. This lifetime indicates the times at which the memory area must be present in the total memory. The first memory 202 and the second memory 204 form the total memory.

A step 304 is subsequently executed.

In step 304, it is determined for the operations which memory areas in the main memory, i.e., in the first memory 202, must be present for the execution of the particular operation.

A memory area or memory areas that do not need to be in the main memory for a particular operation can potentially be moved to secondary memory to execute the particular operation.

In step 304, it is determined for the operations which memory areas may be present in the secondary memory, i.e., in the second memory 204, during the execution of the particular operation.

For example, the memory areas in the list are marked accordingly.

A step 306 is subsequently executed.

In step 306, the memory plan is determined depending on whether a memory area must be present in main memory or may be present in secondary memory for execution.

For example, for each operation, an assignment of the memory areas either to the main memory or to the secondary memory is determined.

For example, the assignment that minimizes the number of transfers of memory areas between the main memory and the secondary memory is determined.

The assignment is determined, for example, using a satisfiability modulo theories solver (SMT solver). An example of an SMT solver is the SMT solver Z3: L. M. de Moura and N. Bjørner. Z3: An efficient smt solver. In C. R. Ramakrishnan and J. Rehof, editors, TACAS, volume 4963 of Lecture Notes in Computer Science, pages 337-340. Springer, 2008.

The method may include a step 308.

In step 308, the memory areas for executing the operations according to the memory plan 200 are provided.

This means that the memory areas are transferred from the first memory 202 to the second memory 204 according to the memory plan 200.

This means that the memory areas will be transferred from the second memory 204 to the first memory 202 according to the memory plan 200.

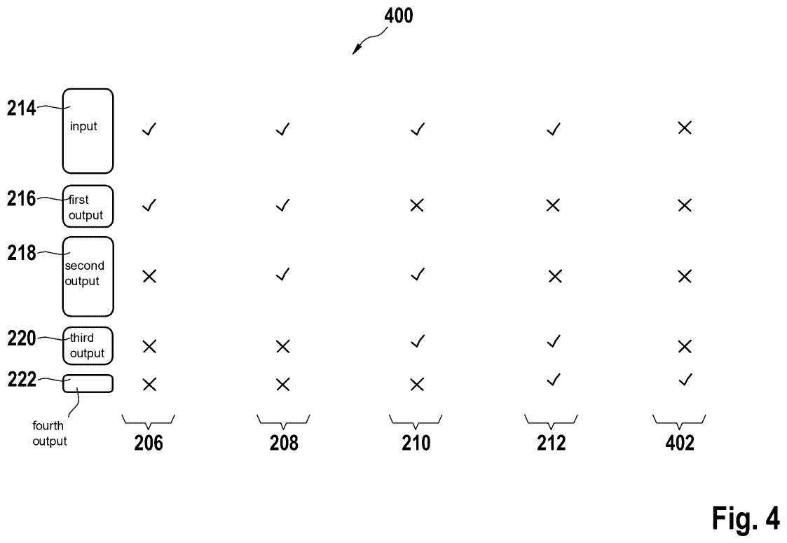

FIG. 4 shows an example 400 of the list with the first operation 206, the second operation 208, the third operation 212 and a result 402. The check mark indicates a required lifetime of the data marked with the check mark. The cross indicates times when no memory is required for the data marked with the cross.

For the memory plan 200, the first operation 206, the second operation 208, the third operation 210 and the fourth operation 212 are marked as the lifetime of the input 214. For the memory plan 200, the first operation 206 and the second operation 208 are marked as the lifetime of the first output 216. For the memory plan 200, the second operation 208 and the third operation 210 are marked as the lifetime of the second output 218. For the memory plan 200, the third operation 210 and the fourth operation 212 are marked as the lifetime of the third output 220. For the memory plan 200, the fourth operation 212 and the result 402 are marked as the lifetime of the fourth output 222.

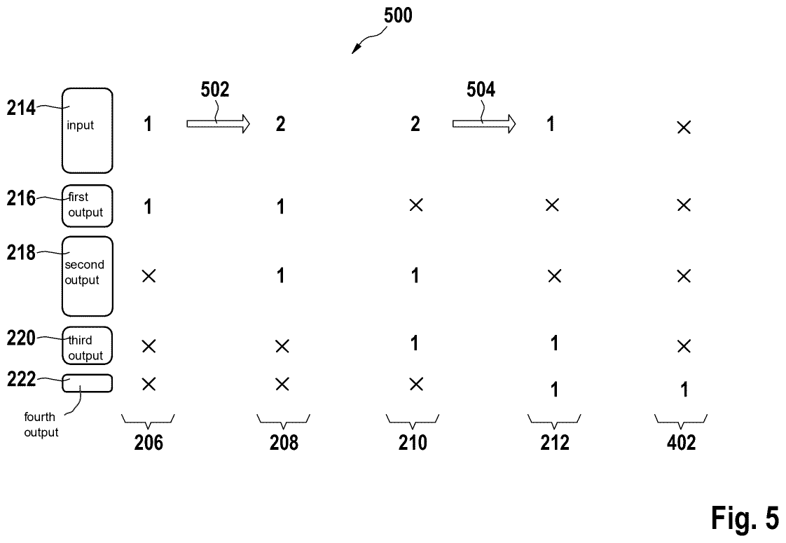

FIG. 5 shows an example 500 of the assignment with the first operation 206, the second operation 208, the third operation 212 and the result 402.

In the assignment, the number 1 indicates that the data marked with the number 1 is assigned a memory area in the main memory, e.g., in the first memory 202. In the assignment, the number 2 indicates that the data marked with the number 2 is assigned a memory area in the secondary memory, e.g., in the second memory 202. In the assignment, a cross indicates that no memory is required for the data marked with the cross.

For the memory plan 200, the input 214 is assigned the number 1, i.e., the first memory 202, for the lifetime during the first operation 206 and the fourth operation 212, and the number 2, i.e., the second memory 204, for the lifetime during the second operation 208 and the third operation 210.

For the memory plan 200, the first output 216 is assigned the number 1, i.e., the first memory 202, for the lifetime during the first operation 206 and the second operation 208. For the memory plan 200, the second output 218 is assigned the number 1, i.e., the first memory 202, for the lifetime during the second operation 208 and the third operation 210. For the memory plan 200, the third output 220 is assigned the number 1, i.e., the first memory 202, for the lifetime during the third operation 210 and the fourth operation 212. For the memory plan 200, the fourth output 222 is assigned the number 1, i.e., the first memory 202, for the lifetime during the fourth operation 212 and during the result 402. At other times, the input 214 and the respective outputs are each assigned a cross, i.e., no memory.

That is, the memory plan 200 provides for a memory transfer 502 from the first memory 202 to the second memory 204 between the first operation 206 and the second operation 208. That is, the memory plan 200 provides for a memory transfer 504 from the second memory 204 to the first memory 202 between the third operation 210 and the fourth operation 212.

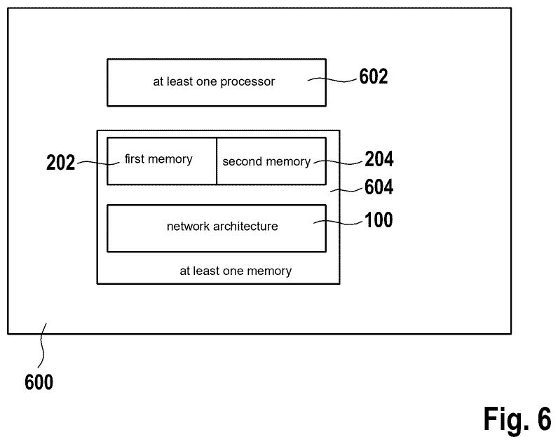

FIG. 6 schematically shows an apparatus 600 for determining the memory plan 200 for executing operations of the artificial neural network having the network architecture 100.

The apparatus 600 comprises at least one processor 602 and at least one memory 604.

The at least one memory 604 includes the first memory 202 and the second memory 204.

The at least one memory 604 comprises instructions executable by the at least one processor 602, upon the execution of which by the at least one processor 602, the method for determining the memory plan 200 is executed.

The method and apparatus 600 are described by way of example for determining the memory plan 200 for two memories. The apparatus 600 can provide more than two memories. The method is applied accordingly for more than two memories.

1-5. (canceled)

6. A computer-implemented method for determining a memory plan for executing operations of an artificial neural network, the method comprising the following steps:
creating a list of memory areas required for executing the operations;
depending on the list, determining for the operations which memory areas must be present in a first memory for executing a respective operation and which memory areas may be present in a second memory during the execution of the respective operation;
determining the memory plan depending on whether a memory area must be present in the first memory for execution or may be present in the second memory;
for each operation, determining an assignment of the memory areas one of the the first memory and to the second memory;
for each operation, marking the memory areas in the list that do not have to be in the first memory are marked; and
determining the memory plan depending on the list with the marked memory areas, and determining the assignment that minimizes a number of transfers of memory areas between the first memory and the second memory.

7. The method according to claim 6, wherein the assignment is determined using a satisfiability modulo theories solver.

8. The method according to claim 6, wherein the memory areas for executing the operations are provided according to the memory plan, wherein certain of the memory areas are transferred from the first memory to the second memory or are transferred from the second memory to the first memory according to the memory plan.

9. An apparatus for determining a memory plan for executing operations of an artificial neural network, the apparatus comprising:
at least one processor; and
at least one memory, wherein the at least one memory includes instructions which can be executed by the at least one processor, and, upon execution of which by the at least one processor, the following steps are executed:
creating a list of memory areas required for executing the operations,
depending on the list, determining for the operations which memory areas must be present in a first memory for executing a respective operation and which memory areas may be present in a second memory during the execution of the respective operation,
determining the memory plan depending on whether a memory area must be present in the first memory for execution or may be present in the second memory,
for each operation, determining an assignment of the memory areas one of the the first memory and to the second memory,
for each operation, marking the memory areas in the list that do not have to be in the first memory are marked, and
determining the memory plan depending on the list with the marked memory areas, and determining the assignment that minimizes a number of transfers of memory areas between the first memory and the second memory.

10. A non-transitory storage medium on which is stored a computer program including computer-readable instructions for determining a memory plan for executing operations of an artificial neural network, the instructions, when executed by at least one processor, causing the at least one comprising the following steps:
creating a list of memory areas required for executing the operations;
depending on the list, determining for the operations which memory areas must be present in a first memory for executing a respective operation and which memory areas may be present in a second memory during the execution of the respective operation;
determining the memory plan depending on whether a memory area must be present in the first memory for execution or may be present in the second memory;
for each operation, determining an assignment of the memory areas one of the the first memory and to the second memory;
for each operation, marking the memory areas in the list that do not have to be in the first memory are marked; and
determining the memory plan depending on the list with the marked memory areas, and determining the assignment that minimizes a number of transfers of memory areas between the first memory and the second memory.
